(19) United States
(12) Patent Application Publication
(10) Pub. No.: US 2009/0300540 A1
(43) Pub. Date: Dec. 3, 2009

(54) SYSTEM, METHOD AND COMPUTER PROGRAM PRODUCT FOR ANIMAL IMAGING

(76) Inventor: Matthew J. Russell, Plano, TX (US)

Correspondence Address: BRIGGS AND MORGAN P.A., 2200 IDS CENTER, 80 SOUTH 8TH ST, MINNEAPOLIS, MN, 55402, US

(21) Appl. No.: 12/473,442

(22) Filed: May 28, 2009

Related U.S. Application Data
(60) Provisional application No. 61/130,222, filed on May 29, 2008.

(51) Int. Cl. G06F 3/048; G09G 5/00; G06T 15/70

(52) U.S. Cl. 715/783; 345/629; 345/473

(57) ABSTRACT

A computer controlled veterinary imaging and diagnostic tool, the tool being performed by execution of computer readable code by at least one processor of at least one computer system, the tool comprising a main viewing area for the presentation of one or more images; a file list viewing area for listing images which can be selected for presentation in the main viewing area; and at least one tab for selection to filter the images listed in the file list viewing area.

### CROSS-REFERENCE TO RELATED APPLICATION

The present application claims priority to, and hereby incorporates by reference hereto, U.S. Provisional Patent Application No. 61/130,222 entitled System, Method, and Computer Program Product for Animal Imaging, filed on May, 29, 2008.

### BACKGROUND OF THE INVENTION

1. Field of the Invention

This invention relates to a diagnostic and imaging software program and apparatus for execution thereof. In particular, the program and apparatus are adapted for use in veterinary practice to facilitate the exchange of information between a veterinarian and an animal owner to improve compliance, education, and treatment.

2. Background

Traditionally, veterinary science reference and diagnostic tools were provided in print media, such as in the form of manuals, books, treatises, journals, and the like. These sources include a wealth of information in the form of images, commentary, formulas, drug information, treatments, and diagnostics for a wide range of animals. Tools of these types are an essential part of every veterinary practice, are found in the collection of every veterinary school, and in the personal library of every veterinary student.

Some of this information is available, in scaled down forms, intended for use by a lay person and/or non-professional animal owner. Tools of this type are often designed to convey less vital information, and are instead focused on education and instruction, rather than on providing specific guidelines for professional treatment and diagnosis.

Very few if any resources are intended to provide both types of information. To date, no tools exists to combine provide these sources of information in an electronic or computerized form.

While computerized tools for use in a wide range of application are now widely available, such tools are less common in veterinary practices. Veterinary practices tends to be small in nature, with a large number of particularly small animal veterinarians practicing in solo or in small group practices. As such, the availability and cost of computerized tools is an obstacle to widespread use. Even to the extent that electronic veterinary tools exist the focus is on the professional practitioner.

As a result, veterinarians—especially those whose practice is focused on companion animals—lack sufficient tools for in-office animal owner education and communication. It is necessary to communicate with the animal owners to assist them in understanding the needs of their animals, the necessary treatments, and the consequences of neglecting treatment. This type of information in difficult to convey orally, especially to the lay person who lacks familiarity with animal anatomy. Furthermore, conventional print media is often not available, not properly organized, or too technical for such purpose. Communicating this type of information is critical for informed decision making and to ensure compliance with follow-on treatment, which often needs to be take place at home under the care of the animal owner.

Accordingly, a need exists in veterinary science for an improved method and apparatus for education, diagnosis, and compliance, and preferably one that takes advantage of computer/electronic systems and methods.

### SUMMARY OF THE INVENTION

An object of the present invention is to provide an improved imaging and diagnostic tool.

These and other objects of the present invention will become apparent to those skilled in the art upon reference to the following specification, drawings, and claims. To that end, the present invention comprises a computer controlled veterinary imaging and diagnostic tool, the tool being performed by execution of computer readable code by at least one processor of at least one computer system, the tool comprising a main viewing area for the presentation of one or more images; a file list viewing area for listing images which can be selected for presentation in the main viewing area; and at least one tab for selection to filter the images listed in the file list viewing area.

### BRIEF DESCRIPTION OF DRAWINGS

FIG. 1 is a screen shot of a main application screen.

FIG. 2 is a screen shot of a content tab and related file list view window.

FIG. 3 is a screen shot of an image thumbnail/preview view.

FIG. 4 is a screen shot of an interactive animal view.

FIG. 5 is a screen shot of a hot spot menu.

FIG. 6 is a screen shot of image overlay selected from the hot spot menu.

FIG. 7 is a screen shot of an interactive neurological screen.

FIG. 8 is a screen shot of an interactive skeletal screen.

FIG. 9 is a screen shot of an interactive musculoskeletal screen.

FIG. 10 is a screen shot of an interactive circulatory screen.

FIG. 11 is a screen shot of an interactive respiratory screen.

FIG. 12 is a screen shot of an interactive digestive screen.

FIG. 13 is a screen shot of an interactive urogenital screen.

FIG. 14 is a screen shot of an interactive animal view and list view.

FIG. 15 is a screen shot of an interactive animal view with labels.

FIG. 16 is a screen shot of a two pane view.

FIG. 17 is a screen shot of a four pane view.

FIG. 18 is a screen shot of a favorites tab.

FIG. 19 is a screen shot of a the content tab showing an add to favorites menu.

FIG. 20 is a screen shot of the add favorites menu.

FIG. 21 is a screen shot of the favorites tab showing thumbnail/preview views of folder contents.

FIG. 22 is a screen shot of a favorites tab menu.

FIG. 23 is a screen shot of a surgery/3d tab.

FIG. 24 is a screen shot of a file drop down menu.

FIG. 25 is a screen shot of an import menu.

FIG. 26 is a screen shot of an import wizard menu.

FIG. 27 is a screen shot of a manage import menu.

FIG. 28 is a screen shot of an edit drop down menu.

FIG. 29 is a screen shot of a tools drop down menu.

FIG. 30 is a screen shot preferences menu.

FIG. 31 is a screen shot of a user interface menu.

FIG. 32 is a screen shot of a folder menu.

FIG. 33 is a screen shot of video menu.

FIG. 34 is a screen shot of an email menu.

FIG. 35 is a screen shot of a handout menu.

FIG. 36 is a screen shot of an import handout menu.

### DETAILED DESCRIPTION OF THE PREFERRED EMBODIMENTS

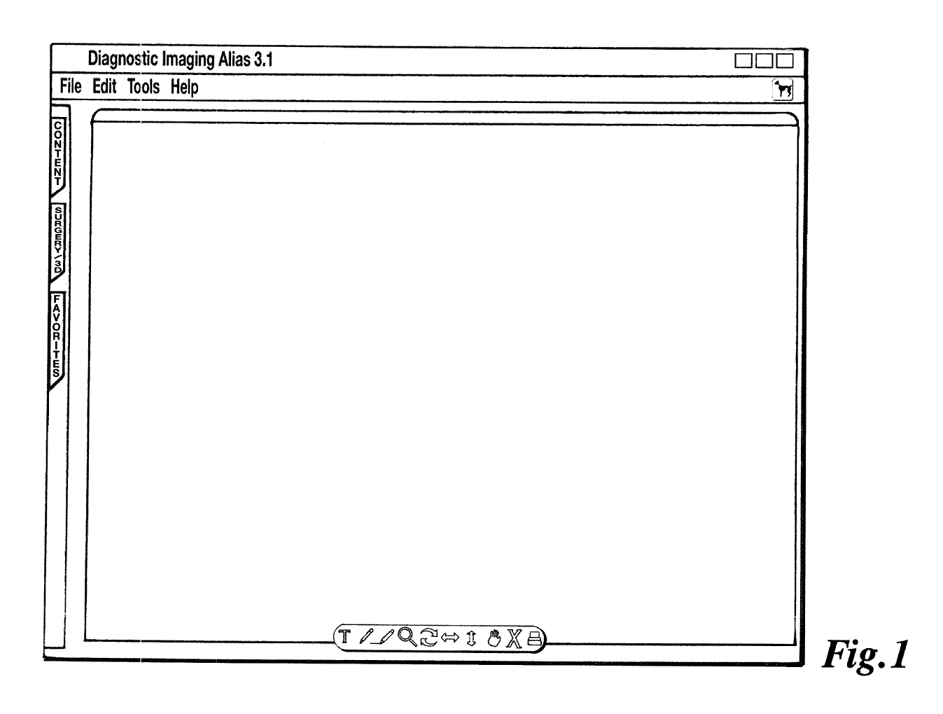

In the Figures, a diagnostic and imaging software application is shown. FIG. 1 shows a screen shot of a main application screen of the software application. The main screen includes a tab portion on the left hand side, a main viewing area which occupies the bulk of the right hand portion of the screen, and a menu section on the top left which features a series of dropdown menus.

The tab section features three tabs that can be used to filter/screen content that will be presented in an array of expanding/collapsing menus appearing between the tabs and a file view section. The tabs are the content tab, the surgery/3d tab, and the favorites tab. The operation of which will be explained in detail hereinbelow.

The content tab filters application content and organizes the content under a plurality of folder categories in the form of expandable/collapsible menus. The content folder categories are animations, clinical images, radiology, and virtual anatomy. Further subcategories are included under each category.

The surgery/3D tab provides a listing of the application animations and videos.

The favorites tab provides access to application selected, or user selected, frequently used content that can be organized in a manner determined by the user.

The content, surgery/3D, and favorites tabs present overlapping content, and as such are not designed to provide mutually exclusive content. All of the content is available for viewing under the content tab, and subsets thereof are available under the surgery/3D and favorites tabs.

Also shown on the upper left of the main application screen is dog/cat interface icon, which when selected brings up a series of tabs and a slider bar selection icon to further filter the presentation material. The operating details of the interface icon feature will be explained in detail hereinbelow.

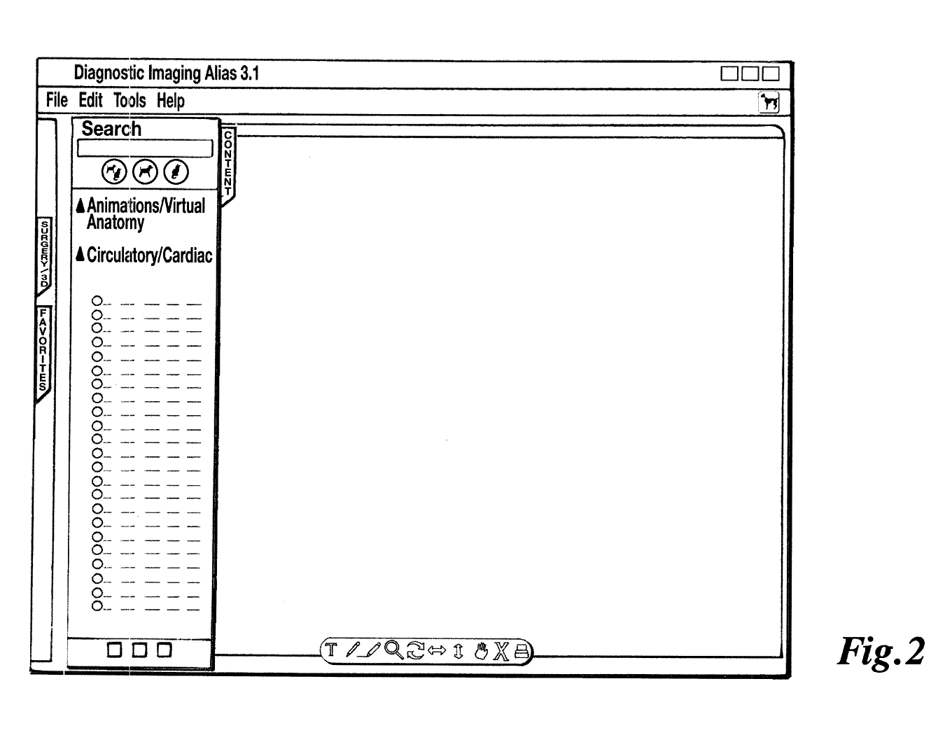

FIG. 2 shows a screen shot of the application after selecting the content tab. As is the general form with each of the three main application window tabs, selecting the content tab moves the tab from the extreme left hand side of the screen to a center left position, which indicates that the content tab has been selected. After selection a series of files appears organized under expandable/collapsible headings in the file list viewing area. Arrows appear next to the headings to indicate if that heading has been expanded or collapsed, and clicking on the arrow will toggle between the two settings.

A search window appears above the file list viewing area that allows the user to type a text string to further limit the content files that appear below the search box in the file list viewing area. A scrollbar appears to the right of the content files in the file list viewing area, which allows the user to select and drag the scrollbar to move through the content files appearing in the file list viewing area.

After the desired content files have been selected, the content of the files is displayed in the main application screen viewing area. The content file is displayed in the main viewing area by double left clicking on the content file with a computer mouse device, or simply left clicking while holding and dragging the file into the main application screen viewing area.

Further content filtering is provided by use of species icons that appear below the text box. The icons include a cat, dog, and cat/dog. Selecting the cat icon limits the displayed content files to only feline specific content files. Selecting the dog icon limits the displayed content files to canine specific content files. Selecting the cat/dog icon displays both dog and cat specific content files. Furthermore, the icons are color coded. The feline icon is red. The canine icon is purple. The dog/cat icon is blue. Icons located to the left of each of the content files in the file list viewing area, are similarly color coded. The feline specific file have a red color, and the canine specific files have a purple color.

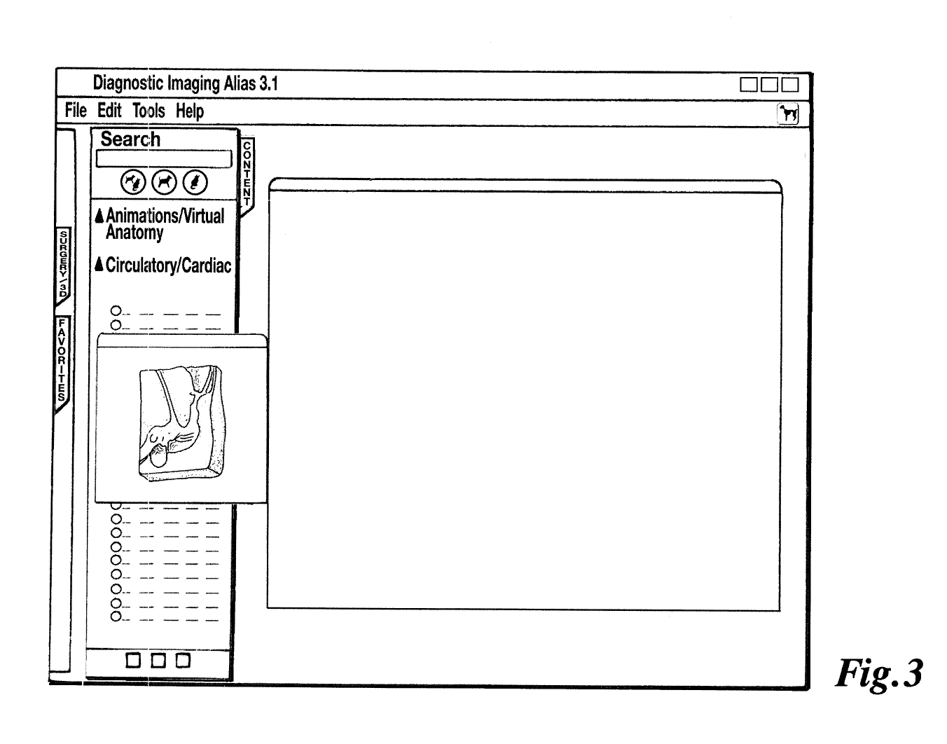

FIG. 3 shows a screen shot of a preview or thumbnail view of a content file. By left clicking on the icon to the left of a file name appearing in the file list viewing area, causes a thumbnail preview of the file to appear. This allows the user to preview multiple files to better select the appropriate file to open in the main application viewing area.

The icon appearing to the left of the content files in the content file listing provides additional information about the nature of the content file. In particular, a letter appears in each icon and the letter corresponds to a type of file content. More specifically, A indicates the file is an animation, E indicates the file is endoscopic, I indicates the file is an illustration, P indicates the file is a photograph, R indicates the file is a radiograph, U indicates the file is an ultrasound, and V indicates the file is a video.

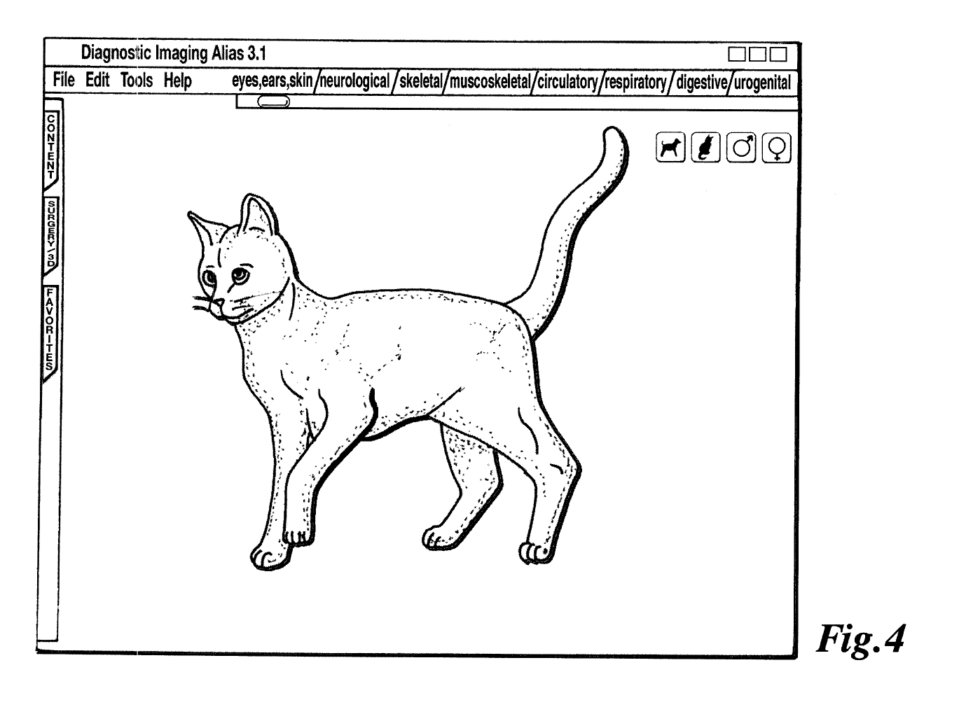

FIG. 4 is a screen shot of the application screen after selecting the dog/cat interface icon shown in the upper right portion of the main application screen of FIG. 1. This opens the interactive animal interface view of the application. The dog/cat interface icon is replaced with four icons to select between interface view of a dog, cat, or male/female.

In this view, an interactive illustration of the animal appears along with a slider bar that allows the user to select between eight different views of the animals anatomical systems. The view shown in FIG. 4 is the eyes, ears, and skin view. To move from systems to system, the user can simply left click and drag the slider to the desired label, or the user can select the label itself by left clicking on the label.

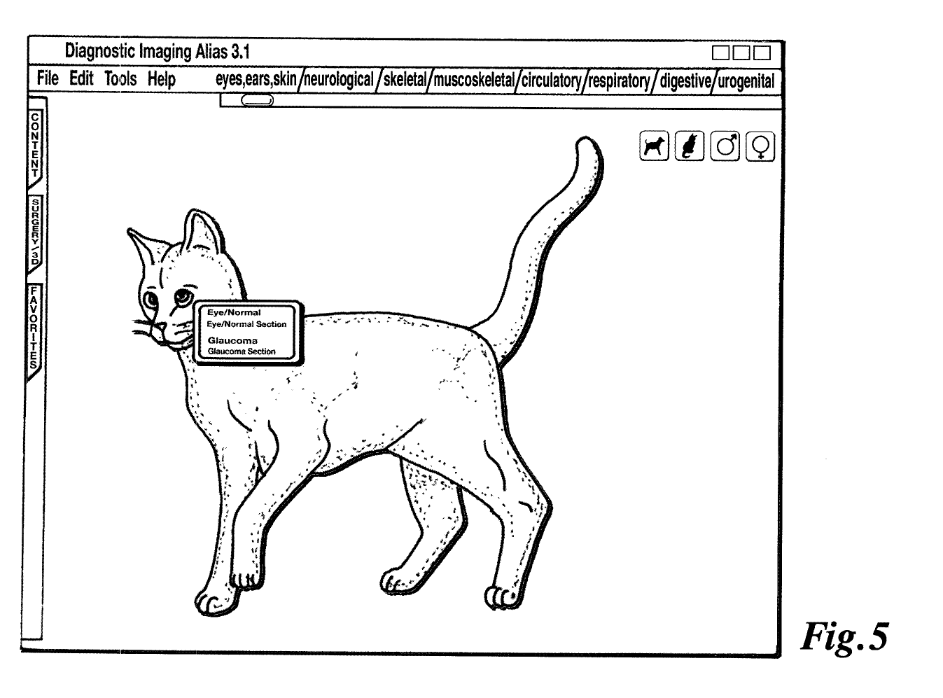

In any of these interactive views the interactive image displayed in the main viewing area is enabled with hotspots that are active if the mouse cursor passes over a component in the particular system displayed in the main view area. FIG. 5 shows a hotspot menu that pops up by right clicking on either eye of the cat shown in FIG. 5. The menu displays a list of files that relate to the animal hot spot selected for interactive view (either cat, dog, or male/female cat or dog). By left clicking on the file name the image appears as an overlay on top of the underlying interactive animal image. The application allows for one or two images to overlay the interactive animal. The system defaults to one or two image overlay and this setting can be changed in the tools menu, described in greater detail hereinbelow.

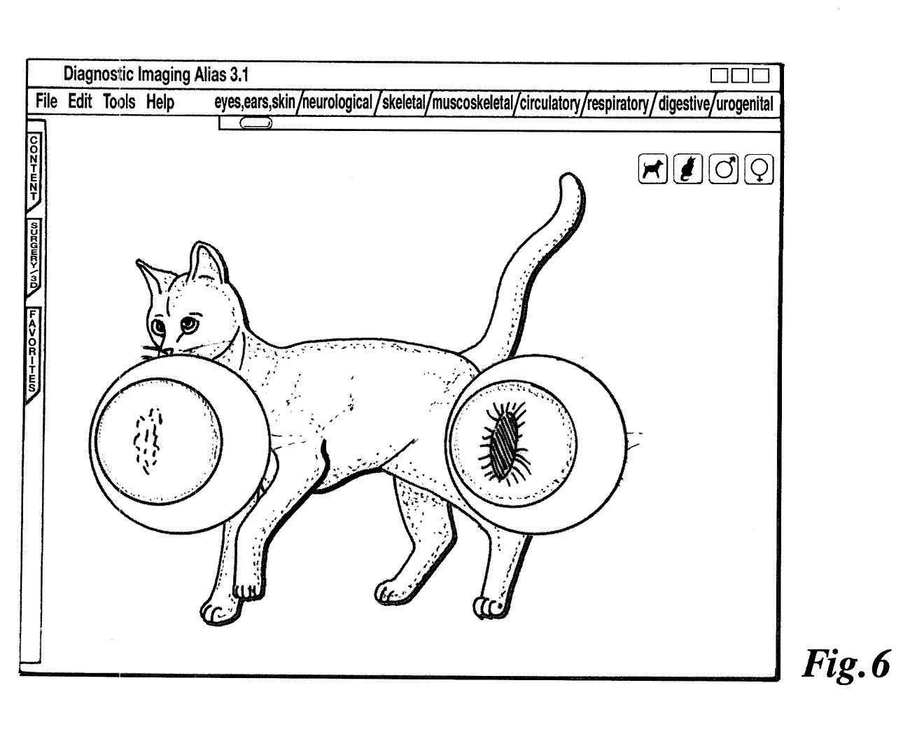

FIG. 6 is a screen shot of the application screen showing two images selected from the hotspot menu shown in FIG. 5. In particular, the image on the right is a normal view of a feline eye, and the image on the left is a view of a feline eye with glaucoma. The images on the right and left can be cleared from the screen by selecting the feline icon in the upper right hand portion of the main application screen, or by selecting clear panes option from the edit drop down menu.

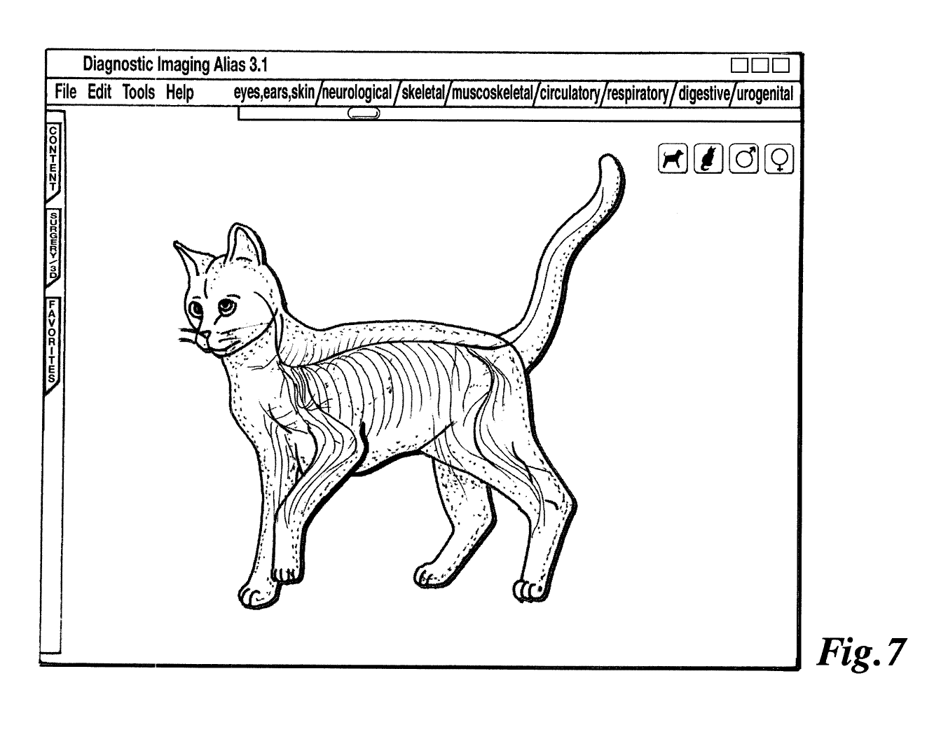

FIG. 7 is a screen shot of the application screen showing the interactive neurological screen for a feline. The neurological system is overlayed on the animal, and all the components of the system are active for hotspot menu file selection in the manner described hereinabove.

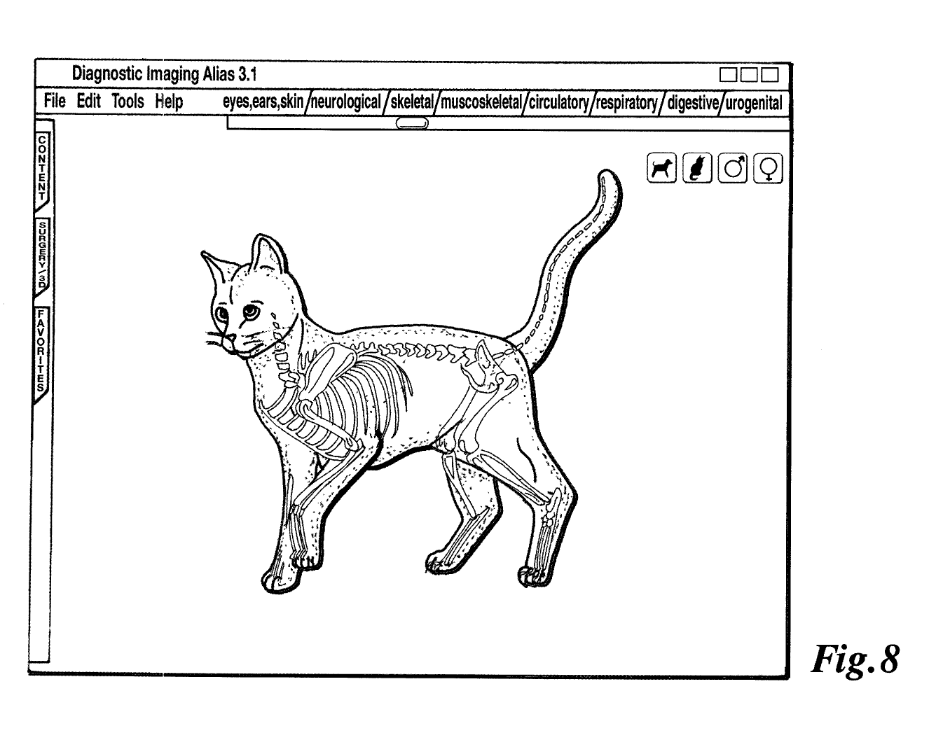

FIG. 8 is a screen shot of the application screen showing the interactive skeletal screen for a feline. The skeletal system is overlayed on the animal, and the components all of the system are active for hotspot menu file selection in the manner described hereinabove.

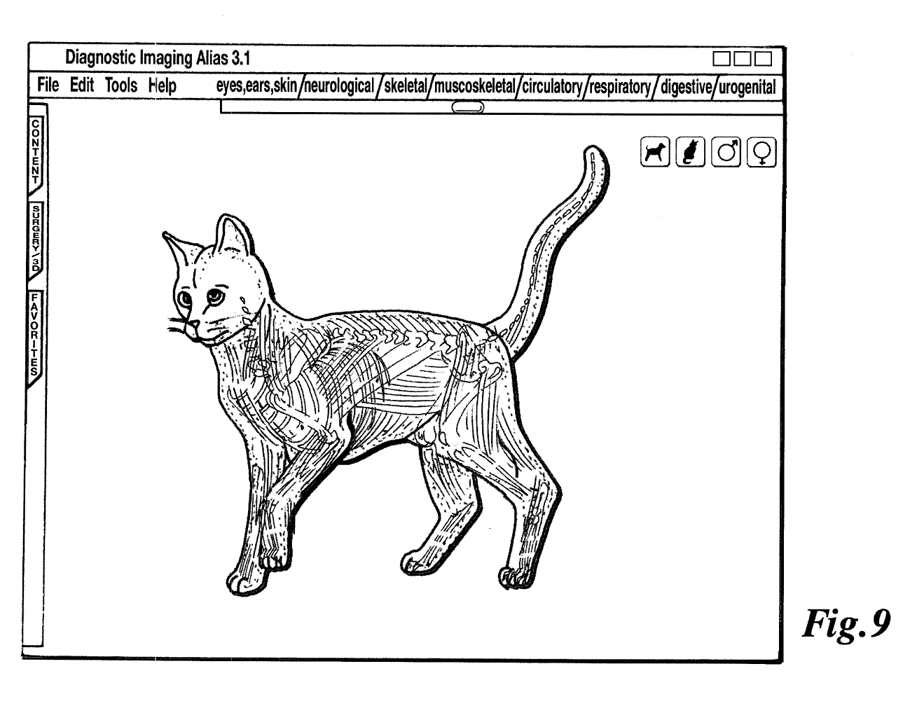

FIG. 9 is a screen shot of the application screen showing the interactive musculoskeletal screen for a feline. The musculoskeletal system is overlayed on the animal, and all the components of the system are active for hotspot menu file selection in the manner described hereinabove.

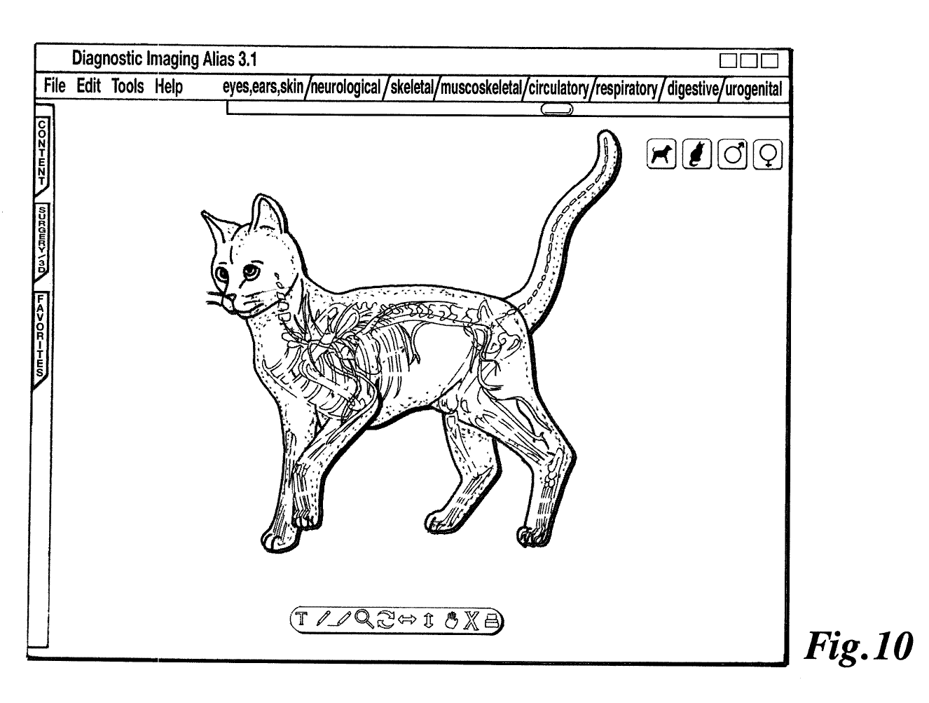

FIG. 10 is a screen shot of the application screen showing the interactive circulatory screen for a feline. The circulatory system is overlayed on the animal, and all the components of the system are active for hotspot menu file selection in the manner described hereinabove.

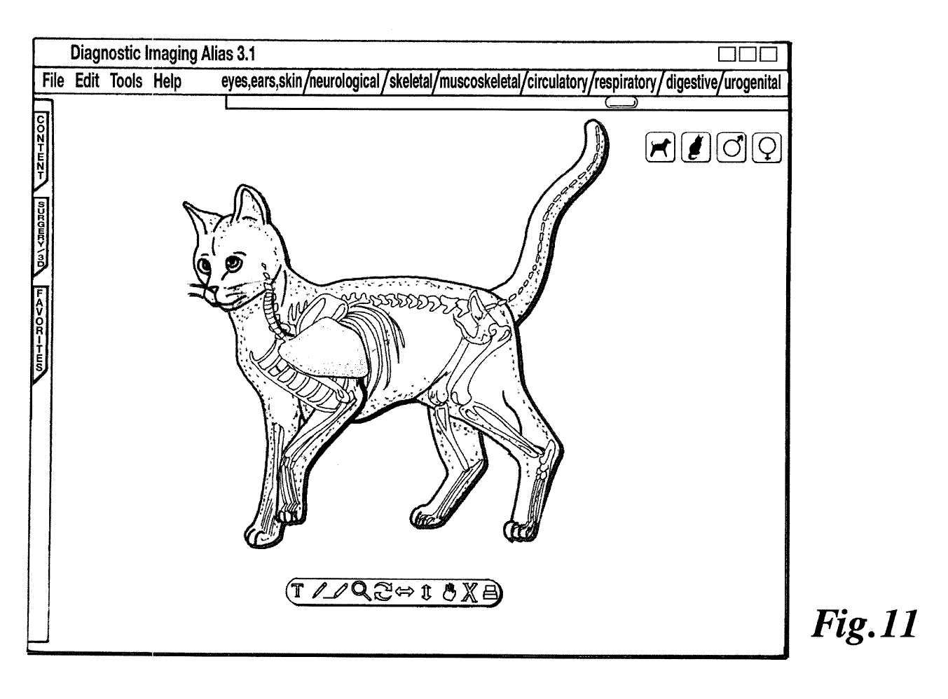

FIG. 11 is a screen shot of the application screen showing the interactive respiratory screen for a feline. The respiratory system is overlayed on the animal, and all the components of the system are active for hotspot menu file selection in the manner described hereinabove.

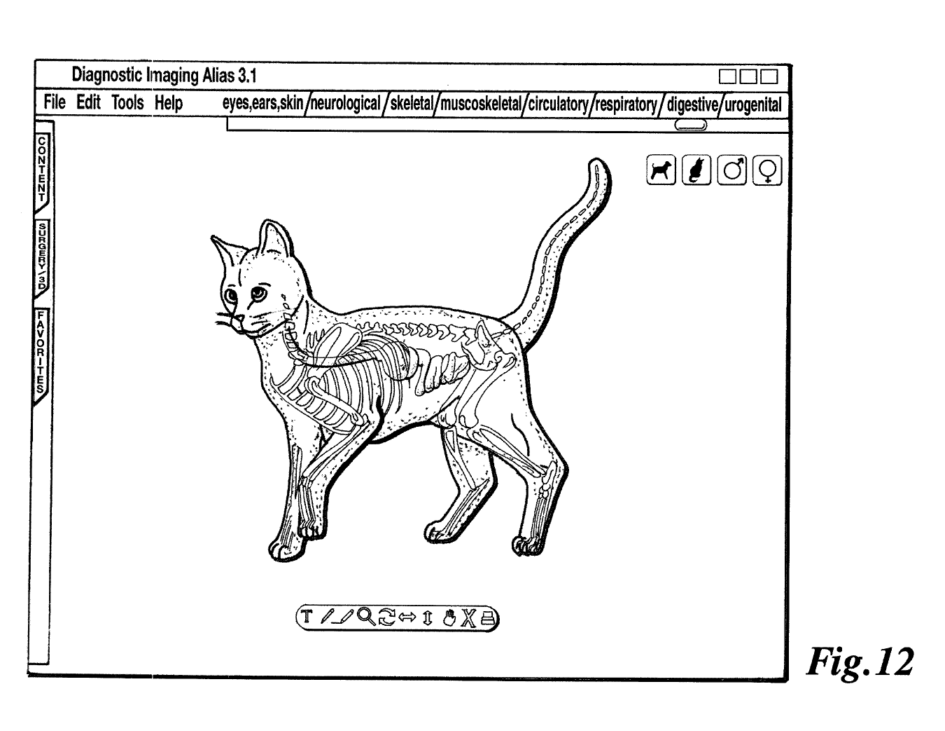

FIG. 12 is a screen shot of the application screen showing the interactive digestive screen for a feline. The digestive system is overlayed on the animal, and all the components of the system are active for hotspot menu file selection in the manner described hereinabove.

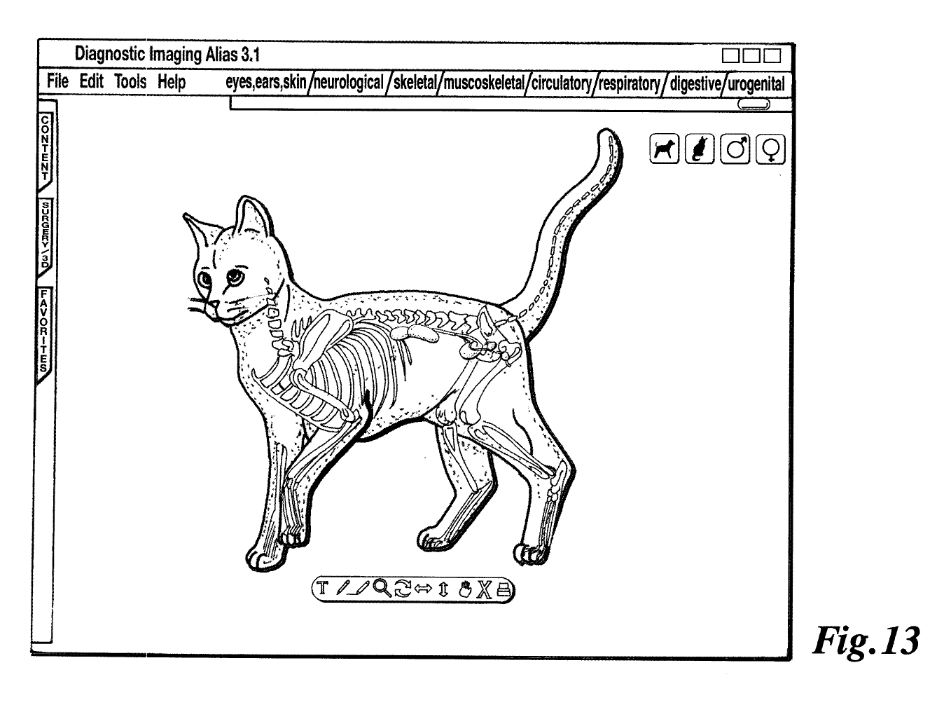

FIG. 13 is a screen shot of the application screen showing the interactive urogenital screen for a feline. The urogenital system is overlayed on the animal, and all the components of the system are active for hotspot menu file selection in the manner described hereinabove.

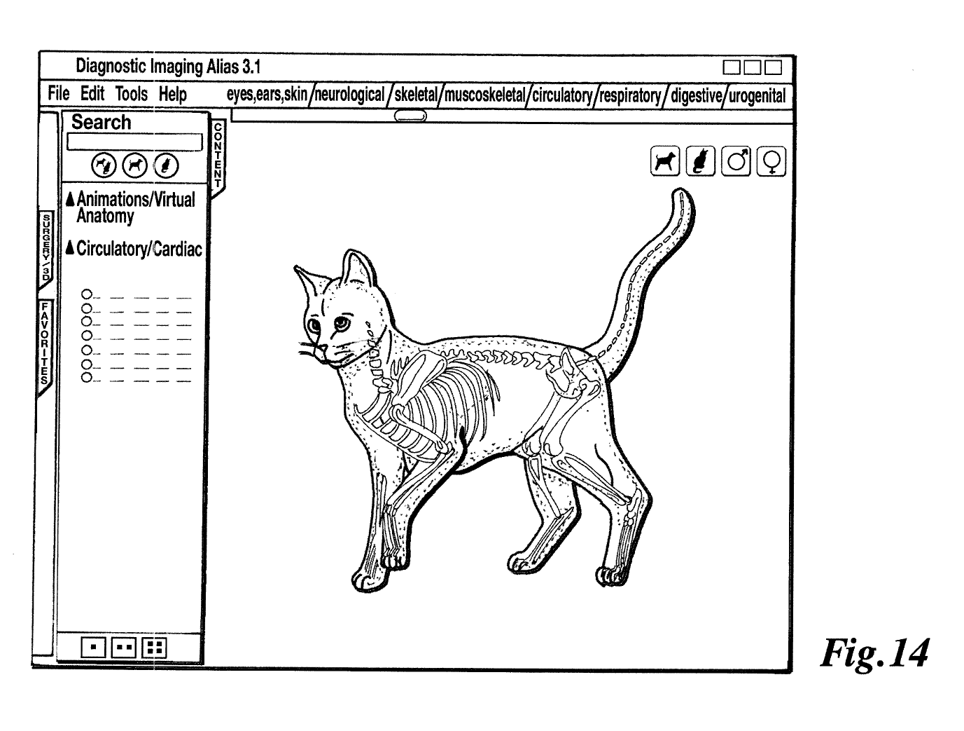

FIG. 14 is a screen shot of the application screen showing the interactive animal view in combination with the list view of files associated with the content tab. Selecting the content tab shows the list view of files, and in this case, because the skeletal tab of the interactive animal screen is also selected, the files listed include only those files associated with the feline skeletal system. The files listed are also the same files that appear in the various skeletal hotspot menus that would be available by moving the mouse cursor over the applicable portions of the feline skeletal system and right clicking. The files can be view/overlayed on the interactive manual by clicking and dragging or double clicking as described hereinabove. In the interactive animal mode, typically only virtual anatomy files would be available for viewing. The foregoing is another of the applications methods for filtering information for display.

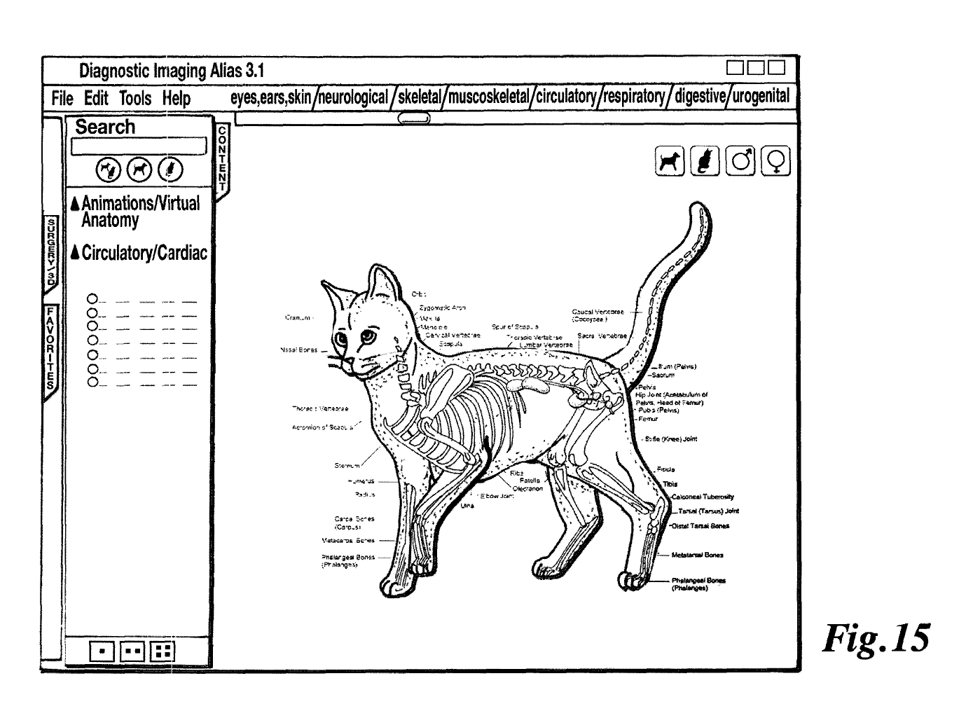

FIG. 15 is a screen shot of the interactive animal view with the labels feature enabled. The labels option is selected from the tools drop down menu, or can be toggled on and off by pressing the alt-1 combination of keys. The label option allows for the display of further information by labeling any information appearing in the viewing area of the main application screen, whether this is an interactive image or any files selected for viewing (labels do not appear for video or animations).

At the center bottom of several of the Figures (see FIG. 13, for example) is an image tool bar. The tool bar includes a plurality of icons that represent tools for manipulating annotating any image that appears in the viewing area of the main application. The tools from left to right are:
A text tool that allows the user to add text to an image. Selecting the tool allows the user to click and drag over the image to create a text box and then type text into the box. The color of the text can be changed by pressing the alt-c combination of letters;
A pencil tool allows for drawing on the image. Selecting the tool allows the user to click and drag over an area of the image to create a pencil line thereon. The color of the pencil can be changed as described hereinabove;
A highlight tools allows for adding transparent highlighting to a portion of an image. Selecting the tool allows the user to click and drag over an area of the image to be highlighted. The color of the highlight can be changed as described hereinabove;
A zoom tool allows for magnifying a portion of the image. Selecting the tool and clicking and dragging over the portion of the image to magnify will increase the size of this portion of the image appearing in the main application viewing area;
A rotate tool allows for rotating the image in 90 degree increments. Selecting the tool and clicking in any portion of the viewing area will rotate the image in the aforesaid increment;
A horizontal flip tool flips the image about a horizontal axis. Selecting the tool and clicking in the viewing area will flip the image;
A vertical flip tool flips the image about a vertical axis. Selecting the tool and clicking in the viewing area will flip the image;
A pan tool allows for moving the image after use of the zoom tool. After zooming onto a portion of an image, selecting the pan tool allows the user to click and drag the image to move a different portion of the image into the viewing area without changing the zoom level;
A clear tool allows for clearing all the image alterations and returning the image to its original unaltered state. Selecting the tool and left clicking will clear all zoom, rotate, and flip manipulations, and left clicking a second time will clear all image manipulations; and
A print tool is also provided for printing an image.

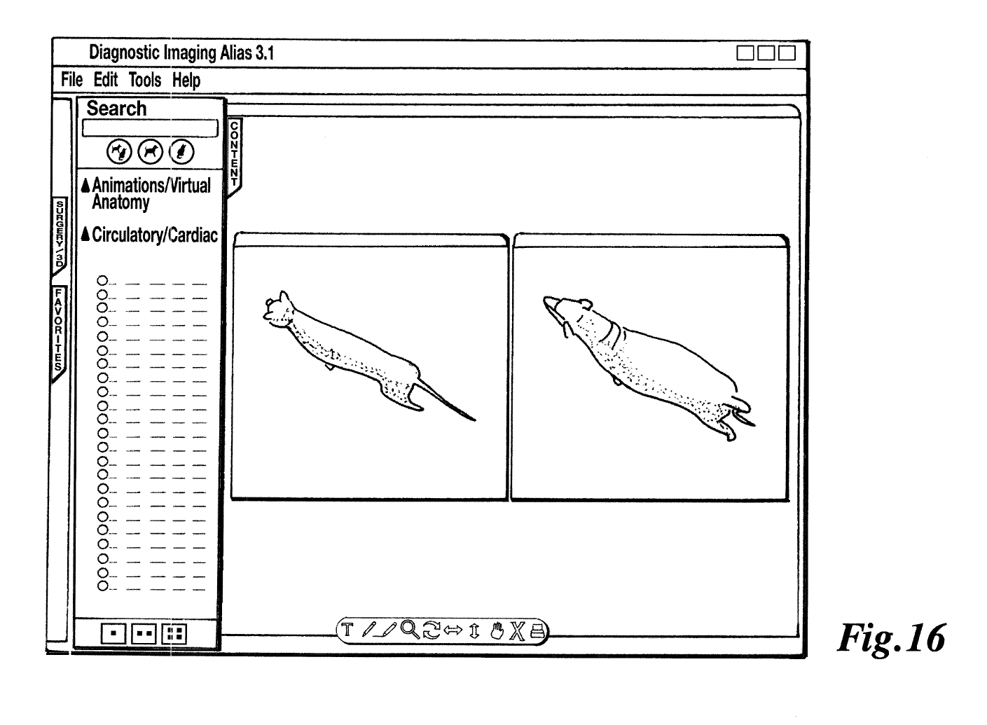

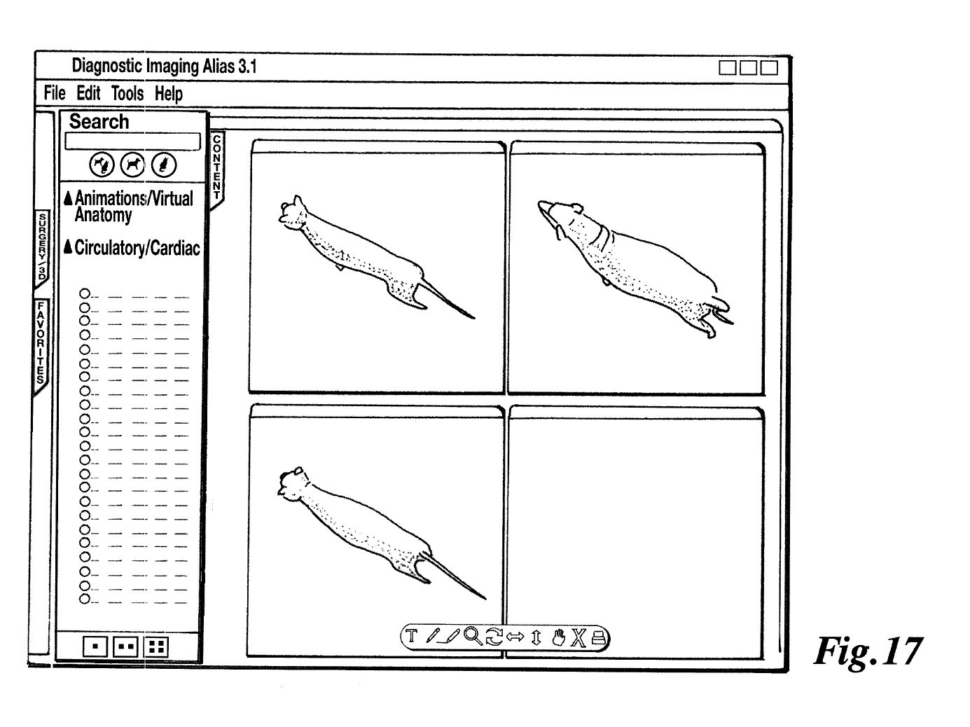

An alternative to the interactive view is the pane view. In the pane view, the main application viewing area is available to allow the user to display selected images in one pane, two panes, or four panes. FIGS. 16 and 17 show examples of two pane and four pane views, respectively. The pane configuration can be selected by clicking on the one, two, or four pane icons located under the file list viewing area at the bottom left of the main application screen.

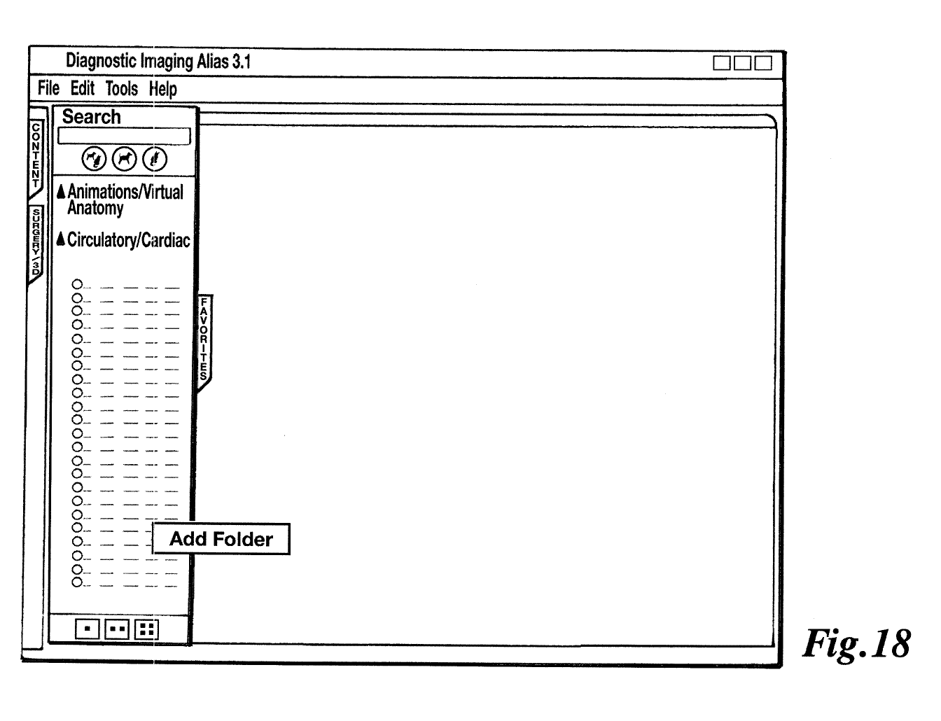

In addition to the content tab, the main application screen includes a favorites tab. FIG. 18 shows application after selecting the favorites tab. The favorites are organized into a series of folders that appear in the file list viewing area. The folders include a plurality of content files that can be of any of the types specified hereinabove. The application comes with certain preloaded favorites, or the user can add or delete favorites as well.

To add a favorites folder, the user can left click in any free space in the list window, which will activate the add folder menu. Clicking on the add folder menu will cause an add new folder window to appear where the user will be prompted to type in the name of the new folder, which will then be added as a new folder in the file list viewing area of the favorites tab.

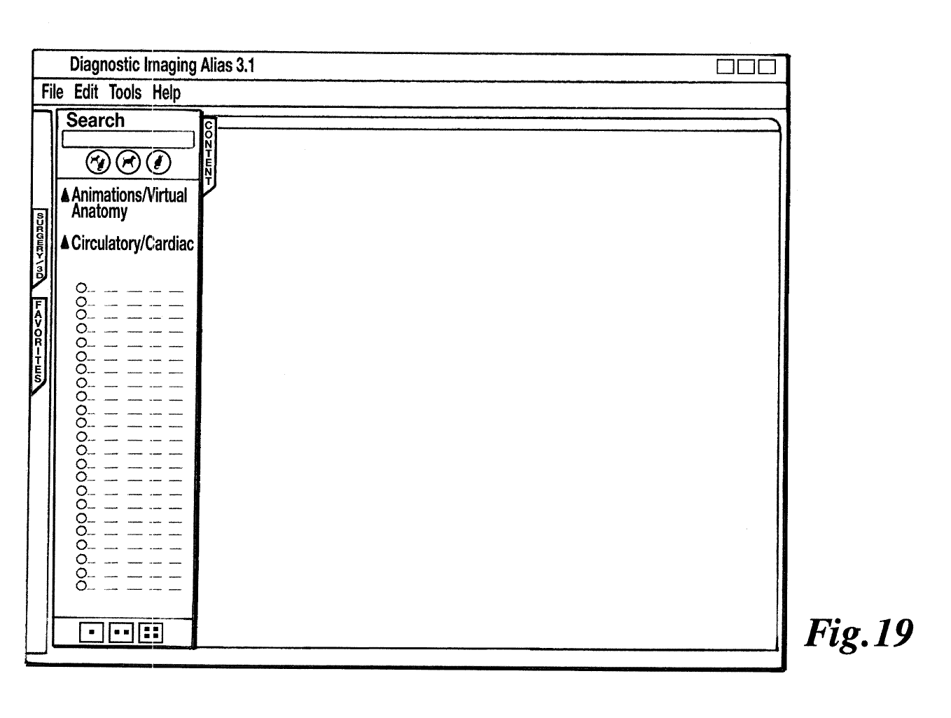

Once the folder is created in the favorites tab, content needs to be added to the folder. FIG. 19 shows a screen shot of the content tab demonstrating this feature. Placing the cursor over a file to be added to the favorite tab and right clicking will bring up the menu shown in FIG. 19. In particular, selecting the add to favorites menu option opens a window for adding favorite content to the favorites tab.

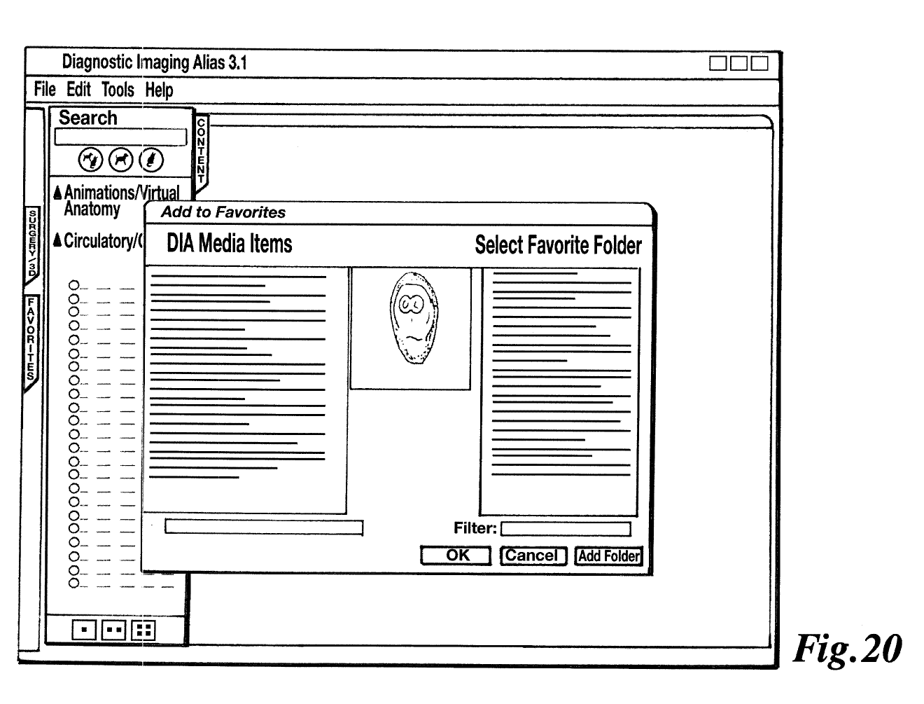

FIG. 20 shows an add to favorites menu that is opened in response to clicking the add to favorites menu option shown in FIG. 19. The add to favorites menu of FIG. 20 lists the content to be added on the left and the favorite folders to add the content to on the right. Both the right and left windows can be filtered to reduce the amount of information to select from/to. Once the desired items are selected from the left window to add to the favorites and the desired favorites folder to add the items to is selected, the ok button is pressed adding the content. Additionally, a new favorite folder can be added if desired by selecting the add folder button. Also, multiple files can be selected for addition to a favorite folder by pressing the control key during file selection.

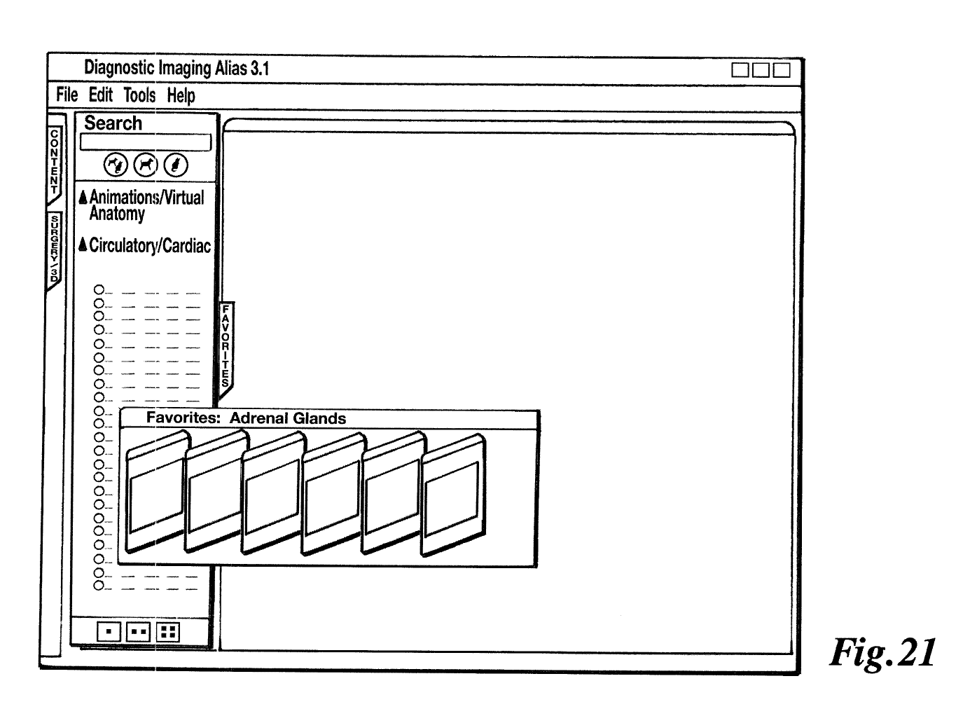

FIG. 21 shows the favorites tab after left clicking on the folder icon appearing next to a folder name in the folder tab. This produces a thumbnail array of the contents of the favorites folder selected. The array of images can be advanced by clicking on the left most image, or images can be transferred to the viewing array by dragging them into the viewing area. Also, the items in the array can be rearranged by left clicking the image while holding down the control key, and dragging the image to the desired position in the array. This will also correspondingly alter the position of the item in the favorites tab file list view area.

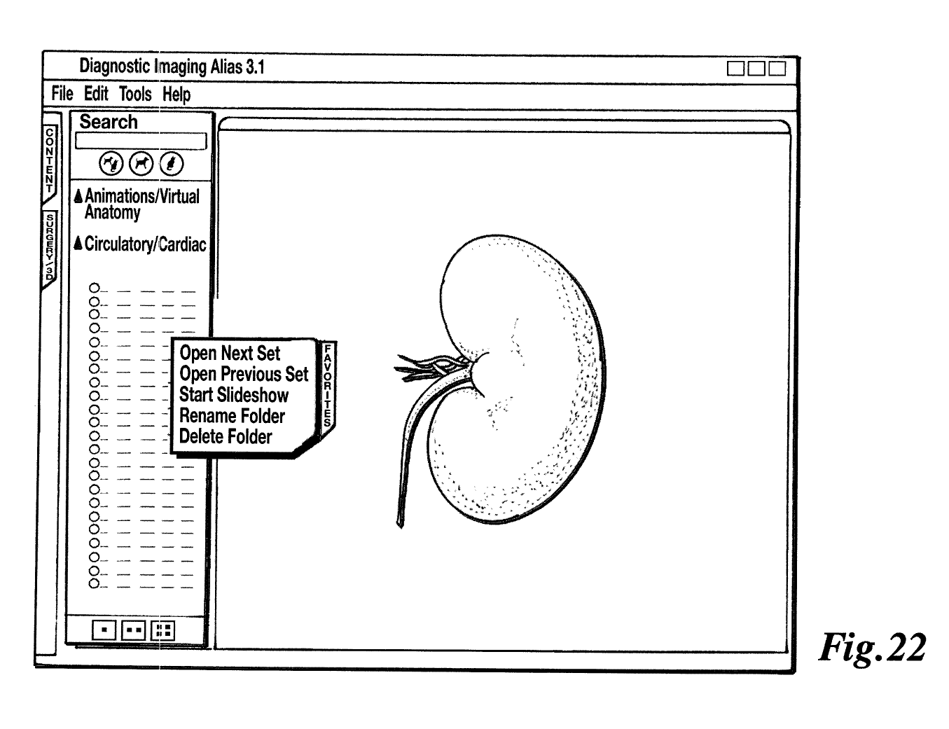

FIG. 22 shows an option menu that appears if you right click on a favorites folder. Selecting the open next set option will open the next/first set of items listed under the folder selected in the main application viewing area. In particular, if the one pane viewing option is selected then the next/first item is opened in the one pane in the main application viewing area. If the two pane option is selected the next/first two items are opened in two panes in the main application viewing area. If the four pane option is selected the next/first four items are opened in the one pane in the main application viewing area. Selecting the open previous set option operates in the reverse manner as the open next set option. The start slideshow opens a slideshow presentation of all of the items in the folder. The slide show can be paused and resumed by left clicking anywhere in the presentation viewing area. The slideshow can be terminated by pressing the escape key. The menu also includes options to rename/delete favorite folders.

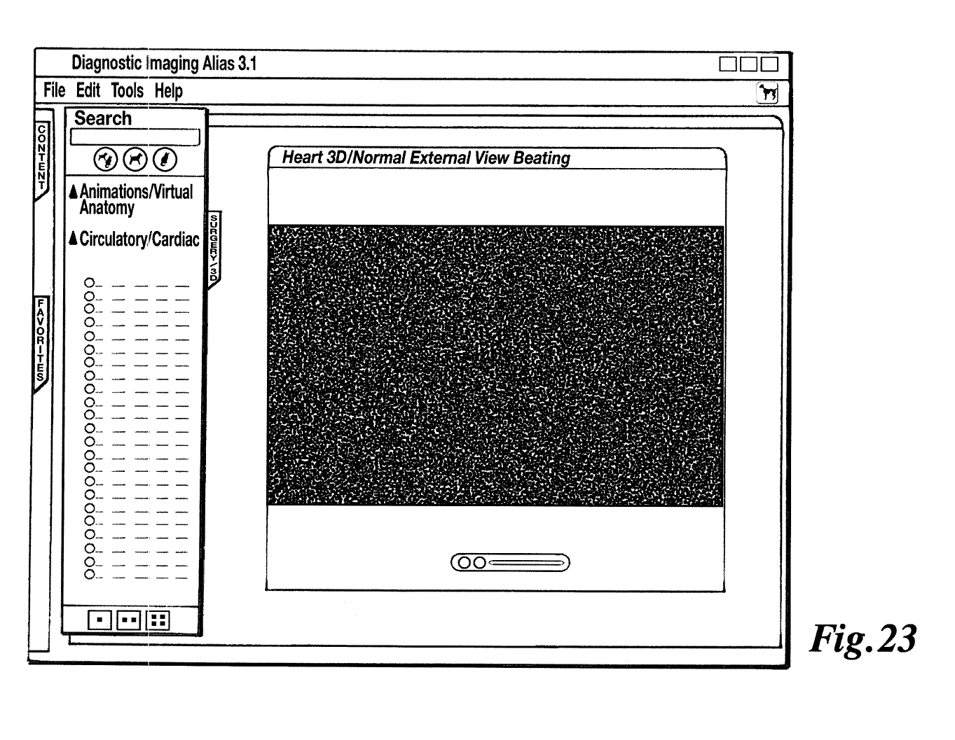

FIG. 23 shows the surgery/3d tab. In this view, all of the animations and videos available in the application are listed in the file list view area. These items can be played by double clicking the item, or clicking and dragging the item to the main application viewing area.

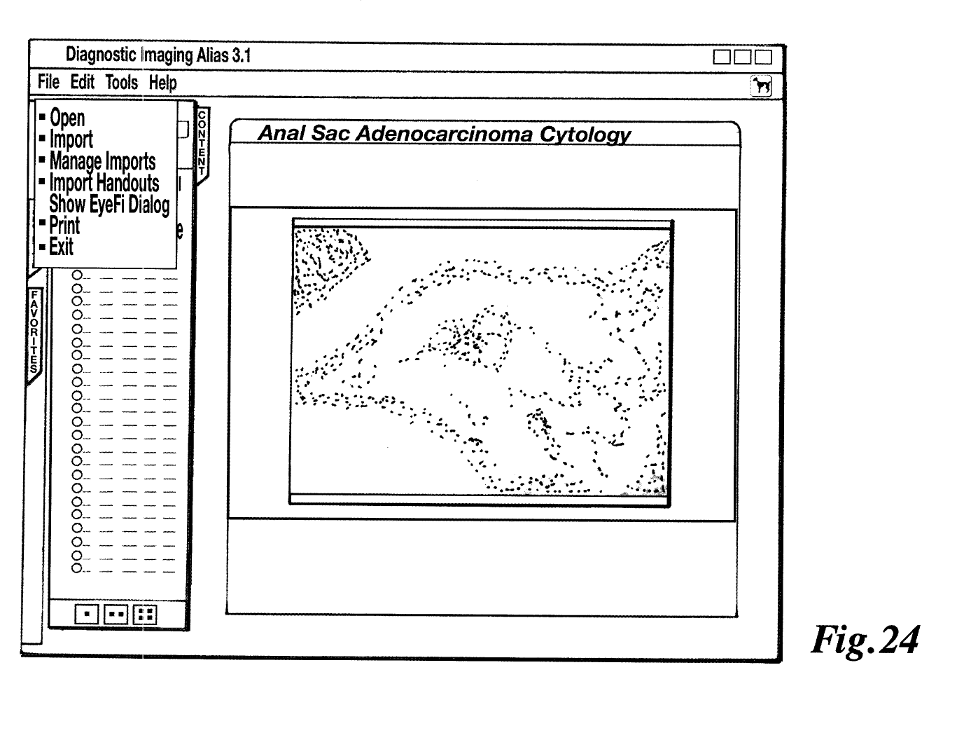

Next, the details of the drop down menus of the application will be described. FIG. 24 shows the file drop down menu. The file menu includes an open option, which allows a user to open a file that will be displayed in the application viewing area (the file does not become a part of the application—the import option provides this capability). The menu also includes a print option to print the current application screen. The menu includes an exit option to close the application.

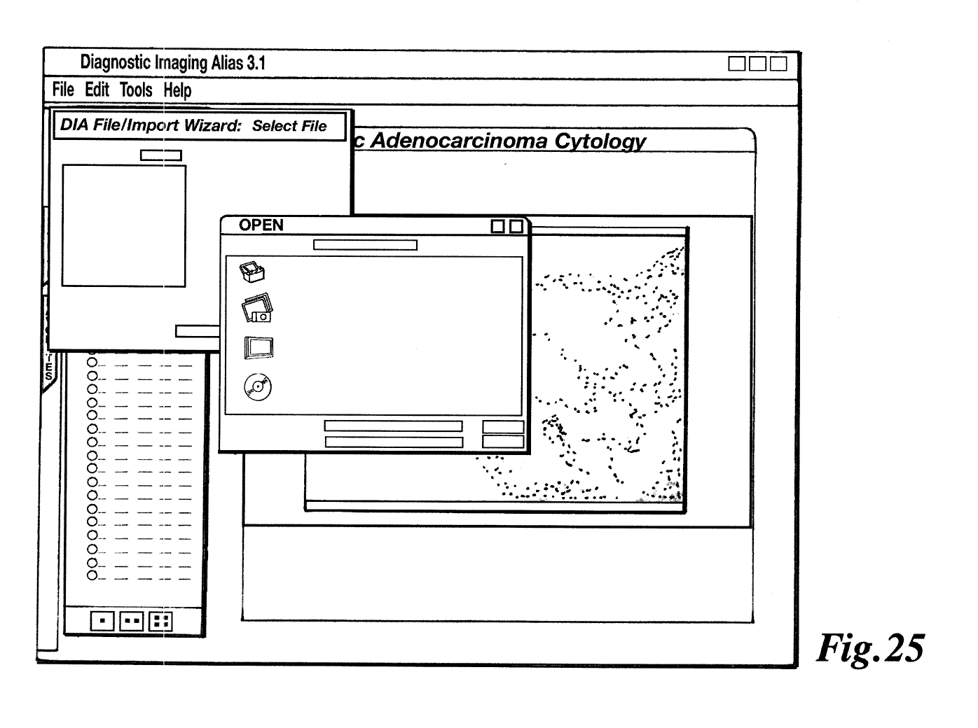

The file menu also includes an import option to allow a user to import content for inclusion into the application. As shown in FIG. 25, selecting the import option opens an import wizard that either lists files for importing (which are files located in a default import directory), or as shown in FIG. 25 a browse option allows a user to select a directory containing the files to import into the application.

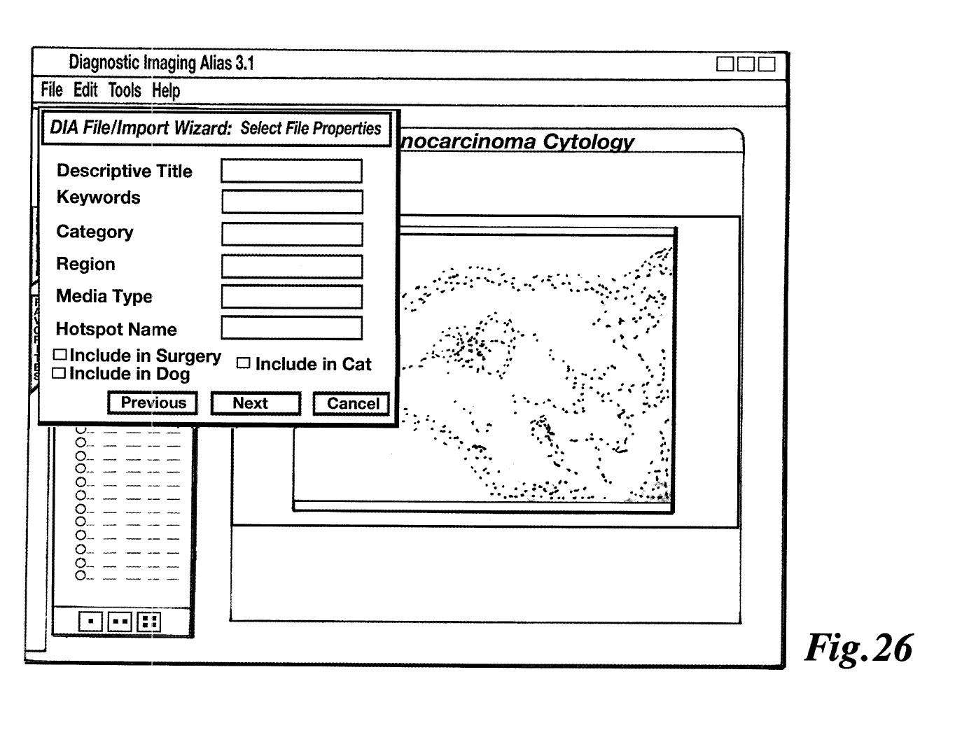

After the files are selected for importing, as shown in FIG. 26, the import wizard displays a file properties screen to allow the user to enter indexing and display information. The information includes the title, any keywords to be used for search purposes, category (such as animation/virtual anatomy, clinical images, radiology), region (such as anatomical region), media type (or file type, i.e. video, image, ultrasound), and hotspot menu (if the file is to be associated with a hotspot menu). The properties menu also includes checkboxes to further categorize the file.

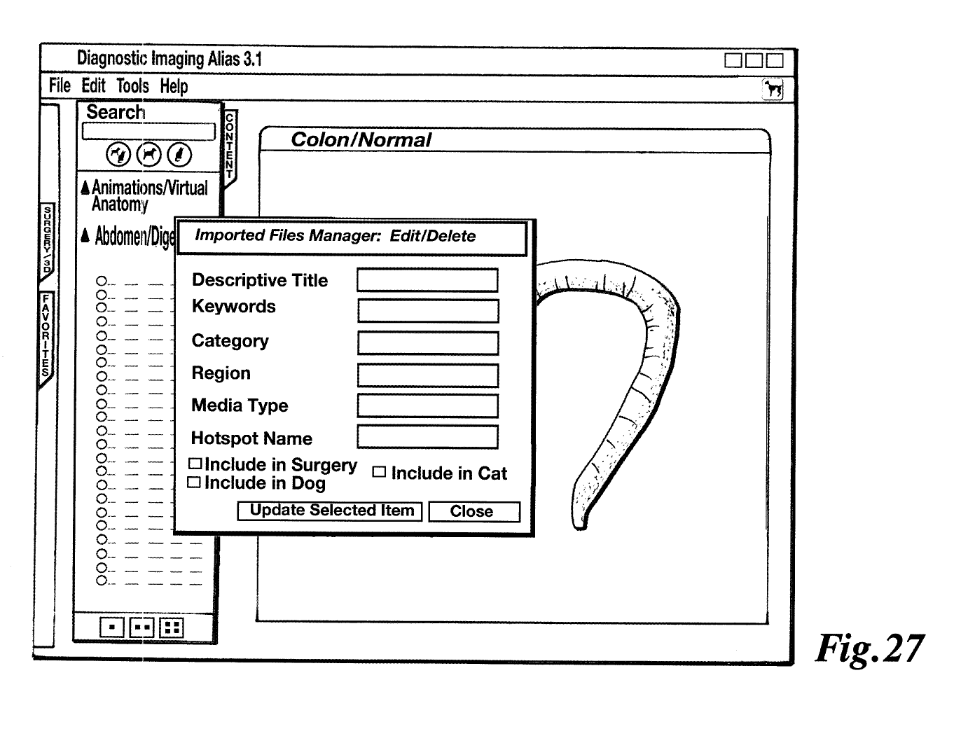

The file menu also includes a manage imports option, which allows the user to edit/delete previously imported files. FIG. 27 shows the manage import screen. A list of imported files appears in the list view box in the upper center of the import files manager menu. The files appearing therein can be deleted, or the file properties edited by clicking on the appropriate file.

The file drop down menu also includes a show eyefi dialog option. Eyefi is a proprietary, commercially available, wireless communication protocol that allow a user to upload images to the application from an eyefi equipped camera/camcorder device. The show eyefi dialog opens a default import folder that contains any files that are available for import via the eyefi protocol.

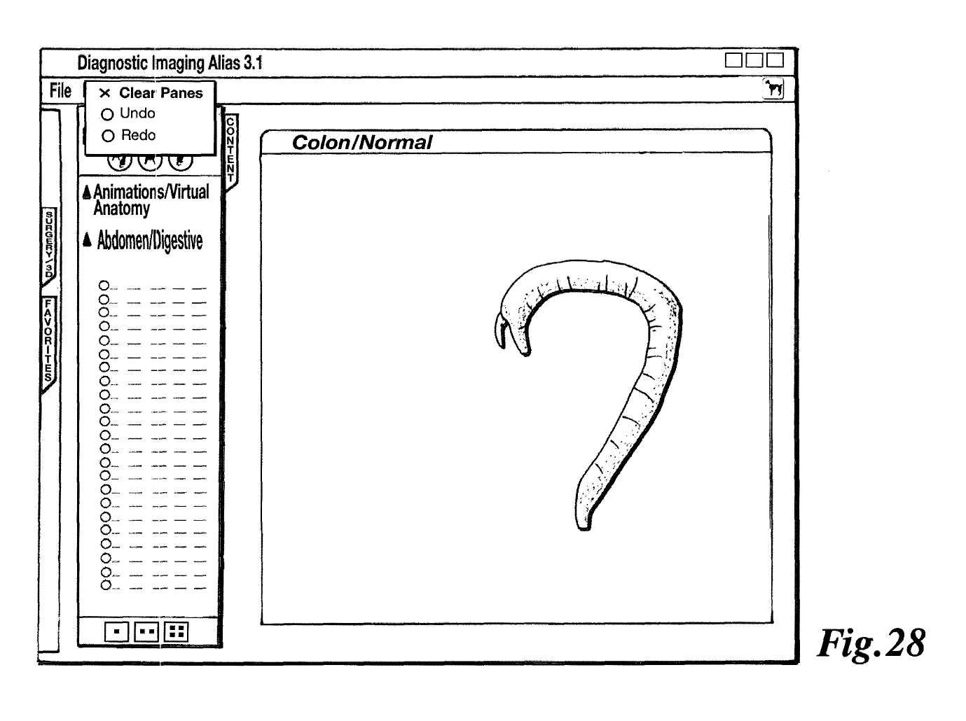

FIG. 28 shows the edit drop down menu. The edit menu includes a clear panes option, which when selected clears all the active viewing panes of images to allow the user to reset the main application viewing area for further processing. The menu also includes undo and redo options to undo changes made to the main application viewing area, or vice versa.

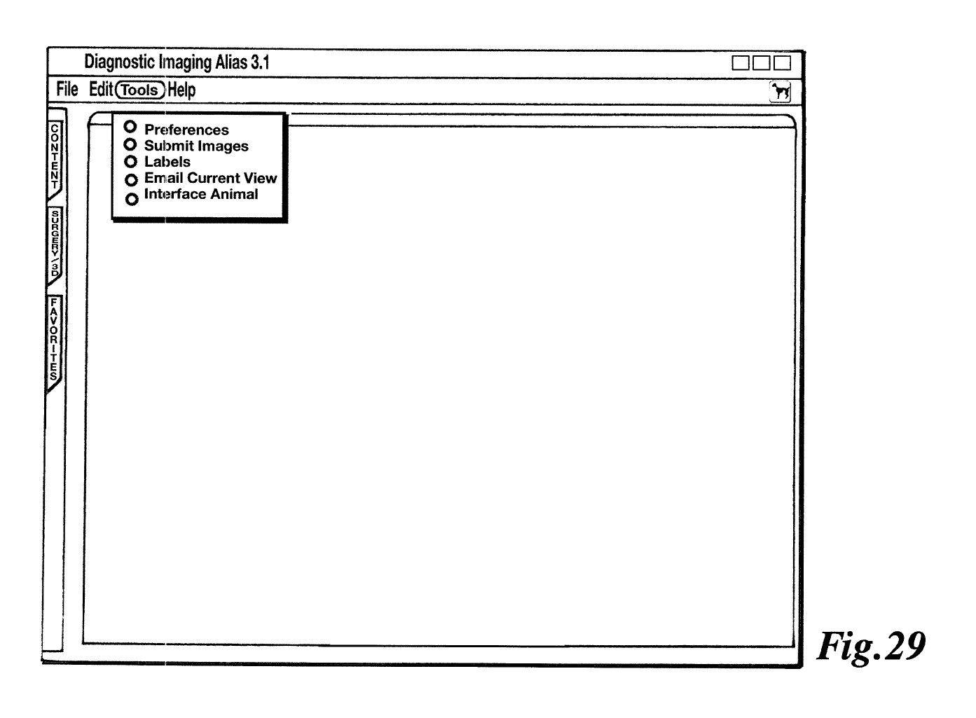

The application also includes a tools screen. FIG. 29 shows the options listed under the tools drop down menu. The first option is a preference menu for setting different types of application settings.

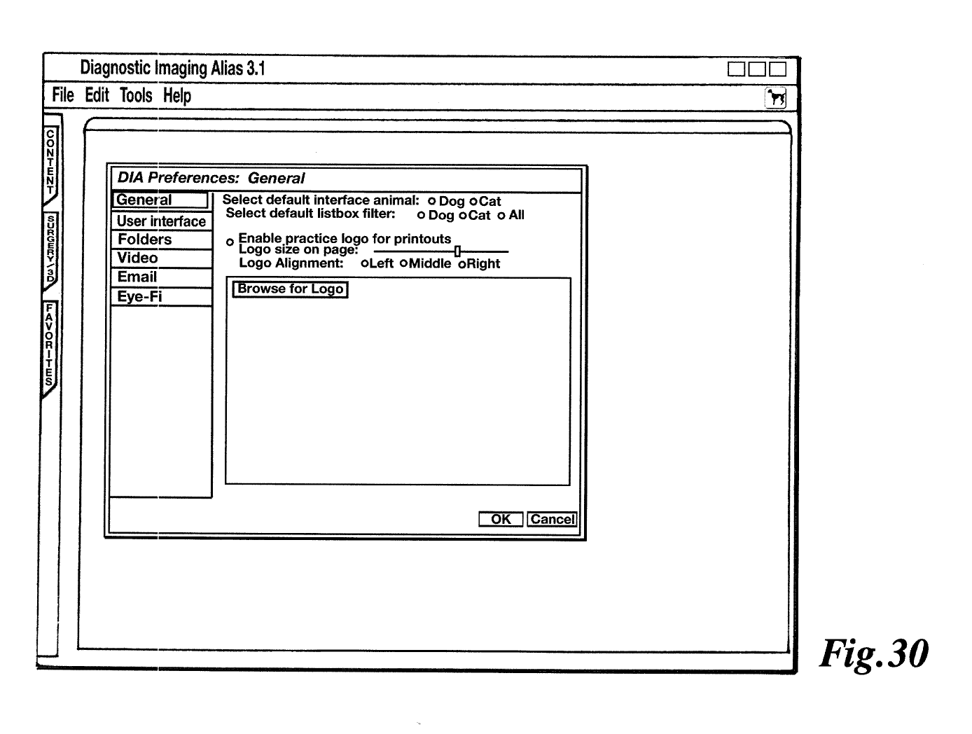

FIG. 30 is a screen shoot of the general preferences screen. The user can select default setting for the interface view, and default filter settings for the file list view. The application also allows users to add a logo (from the users' practice, for example) to application printouts. The general preference settings allow the user to load the logo, and select the size and alignment of the logo upon printing.

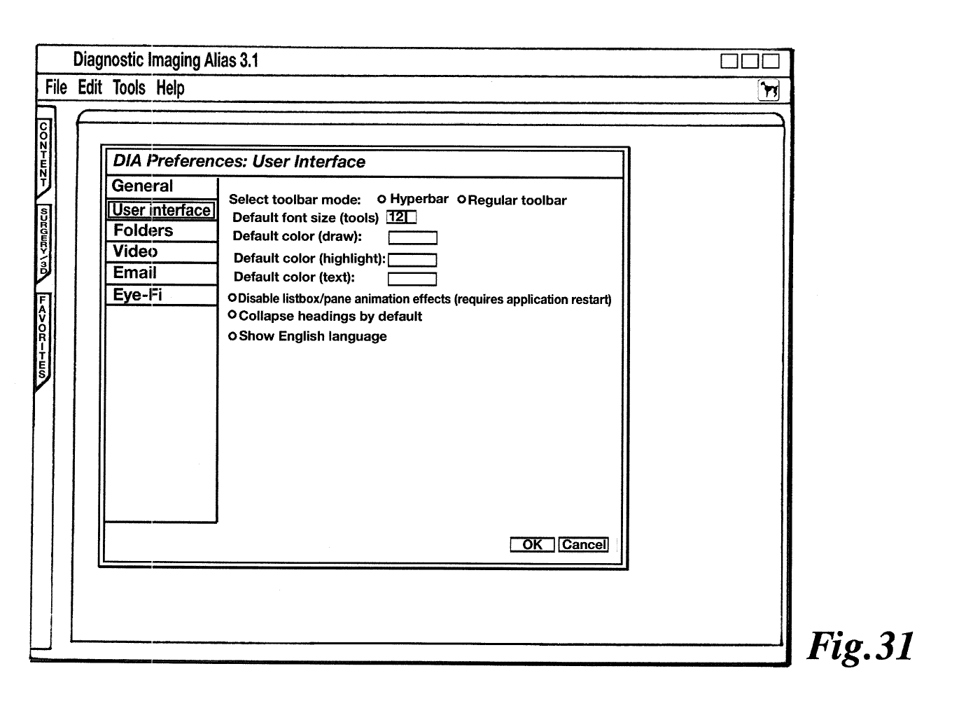

FIG. 31 is a screen shot of the user interface preferences, which allow the user to configure the look of the application windows. The settings include selecting between an animated (hyperbar) and regular setting for the image editing and annotating tools menu, setting the default font size for text, setting default colors, disable/enable transition animation effects for images (this setting may be disabled to increase the speed of the application), and default settings for file headings in the file list view.

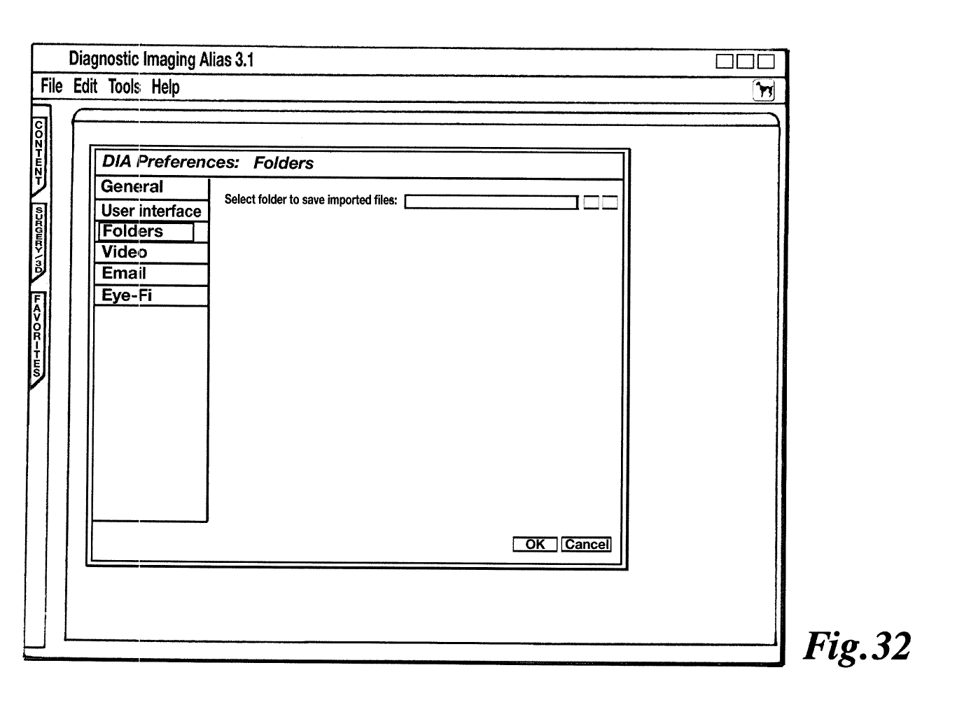

FIG. 32 is a screen shot of the folders preference screen which allows the user to select a default file location for files the user wants to import into the application, which will also serve as the default location for user created additions to the favorites tab as well.

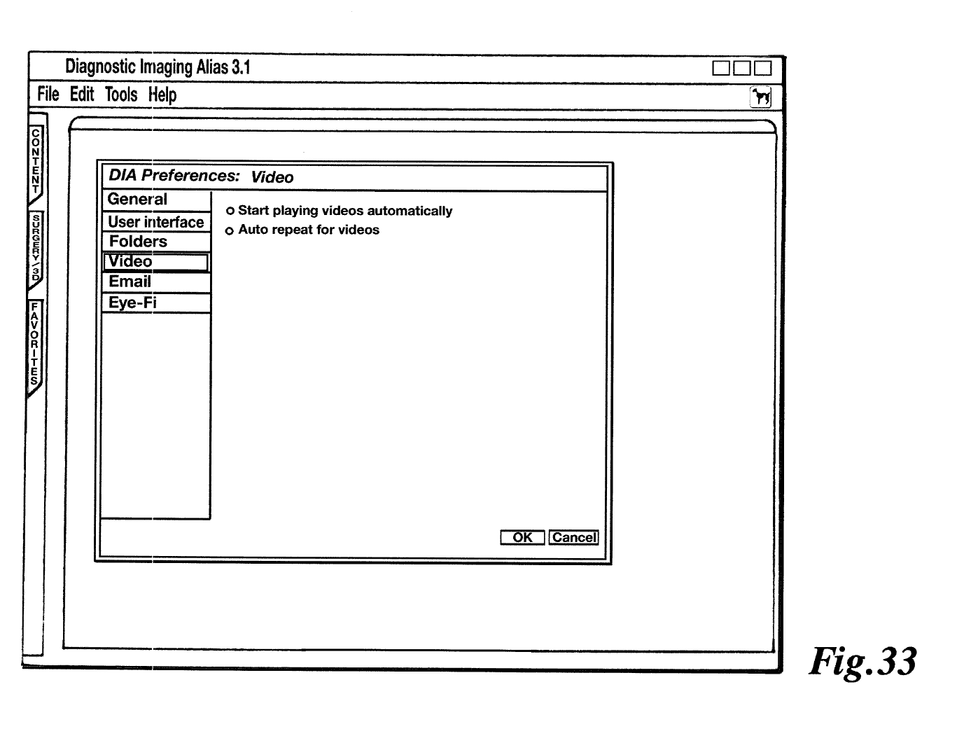

FIG. 33 is a screen shot of a video preference screen that allows the user to select default settings for video playback and for initial play.

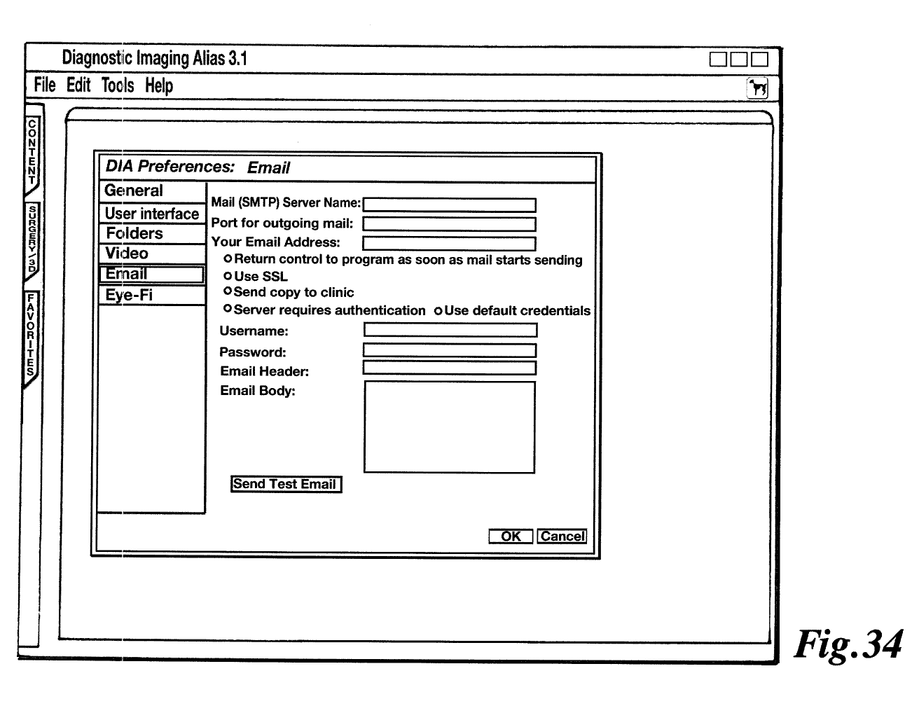

FIG. 34 is a screen shot of an email preference screen. This screen allows the user to setup an email account to which files can be sent in accord with the email tool, which is described hereinbelow.

Also provided in the preferences menu is a screen for configuring the proprietary eyefi wireless communication protocol referred to hereinabove. The settings include selecting a default directory for eyefi files, and a setting for enabling/disabling eyefi integration.

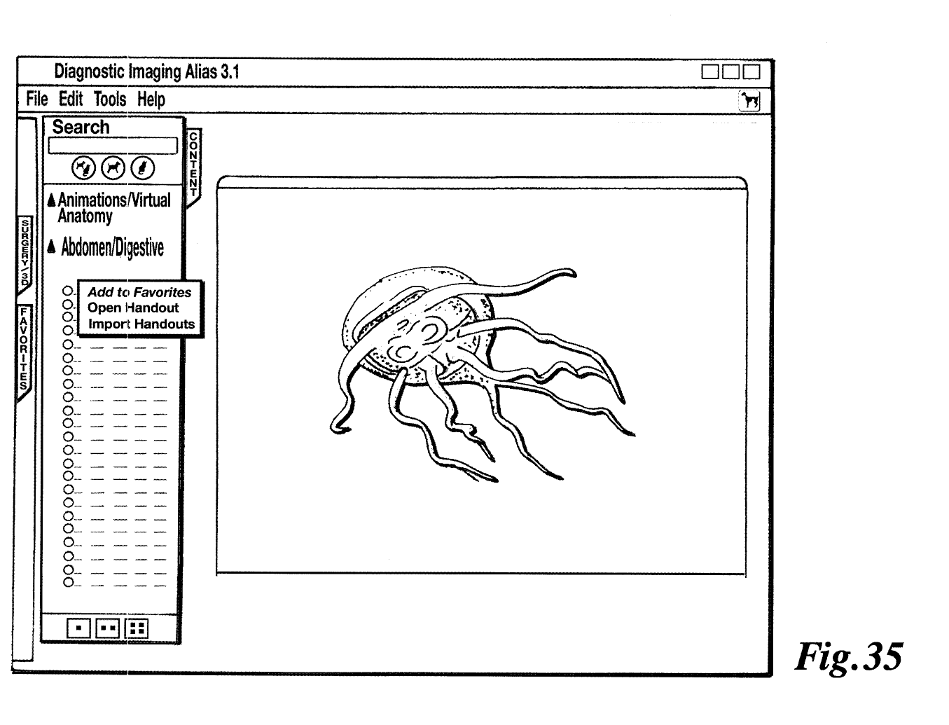

FIG. 35 is a screen shot of a handout menu that appears after right clicking on a file in the file list viewing area. Handouts are printed material that is, or can be, associated with a content file for viewing or printing. The handout can include any manner of additional information and material relevant to the particular file. Two options are provided. The user can open an existing handout by selecting the open handout menu item, or the user can import a new handout to be associated with the particular file.

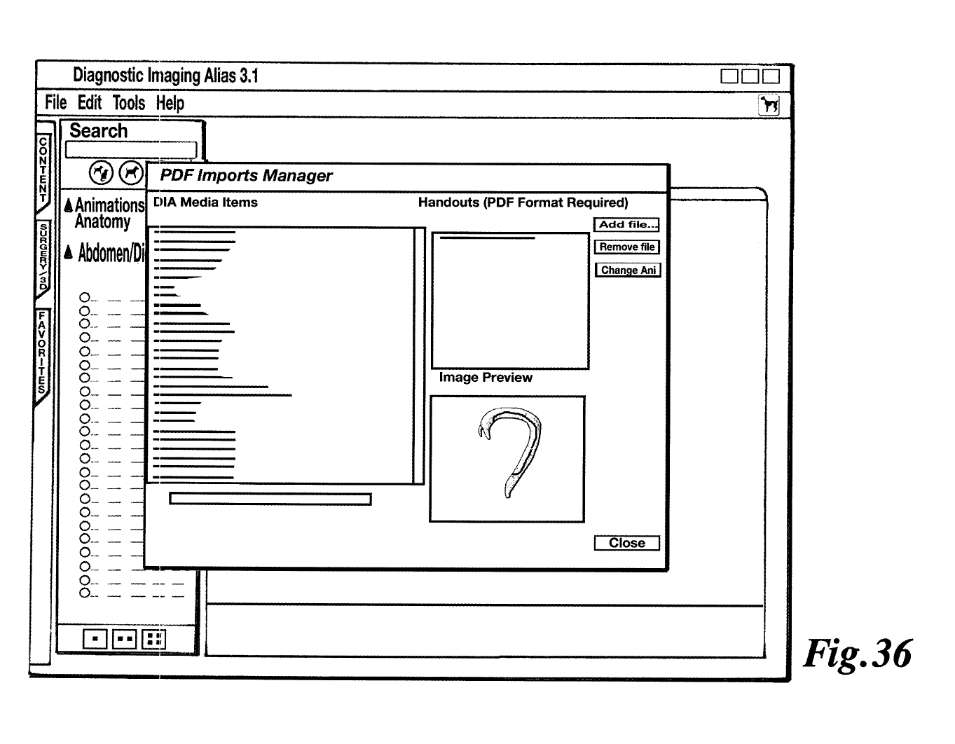

FIG. 36 is a screen shot of the handout import manager screen which appears after selecting the import handout menu option. The screen in FIG. 36 also opens through the import handout option in the file drop down menu (see FIG. 24). A list of files appears in the DIA media items window. A handout is associated with a file by first selecting the content file from the list. The list can be filtered by entering text in the filter box. Next, selecting the add file button will open a window to allow the user to import the handout to be associated with the selected content file. Any existing handouts will appear in the handout window, and that association can be changed by clicking on the click box appearing next to the handout.

The application is adopted for execution on various computer systems utilizing one or more microprocessor/central processing units operating computer executable program code. The computer systems can be comprised of a number of computer systems, or combination of systems, such as a desktop, laptop, personal digital assistant, smart phone, workstation, server, mainframe, microcomputer, and the like. Preferably the computer system is configured with a screen, keyboard, mouse, or the equivalent thereto. The application is executed as a group of executable program files stored on a computer readable medium on one computer, or may be distributed across a plurality of computers. The application can be implemented across one or more computer networks, such as the internet, a wide area network, local area network, or the like.

In this manner, the present invention substantially eliminates the problems of the prior art the application provides a useful diagnostic an imaging tool that can allow medical and/or veterinary professional, layperson, and/or animal owners to visually interact with animal models and component anatomical systems and portions thereof for the purpose of education, diagnosis, instruction, and compliance with patient/animal care instructions and regimens. A particularly useful feature of the application is the ability to view in a side-by-side manner images of healthy and unhealthy conditions. This allows the users to better understand a particular condition, the impact of effective treatment, as well as the important with complying with a particular treatment regimen.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention. For example, while the embodiment described hereinabove is in reference to cats and dogs, it is within the scope of the invention to include other animals such as companion animals, large animals, exotic animals, and the like.

1. A computer controlled veterinary imaging and diagnostic tool, the tool being performed by execution of computer readable code by at least one processor of at least one computer system, the tool comprising:
a main viewing area for the presentation of one or more images;
a file list viewing area for listing images which can be selected for presentation in said main viewing area; and
at least one tab for selection to filter the images listed in said file list viewing area.

2. The tool of claim 1 wherein the images are images of animals.

3. The tool of claim 2 wherein said animals are companion animals.

4. The tool of claim 3 wherein said companion animals are cats and dogs.

5. The tool of claim 1 further comprising a search box for filtering said listing of images in said file list viewing area.

6. The tool of claim 1 further comprising one or more pane icons for selecting a predetermined number of panes for viewing images in the main viewing area.

7. The tool of claim 1 further comprising an animal selection icon for selecting between different types of animals wherein said selection further filters said listing of images in said file list viewing area.

8. The tool of claim 7 further comprising a sex selection icon for selecting the sex of said animal selected with said animal icon for further filtering said listing of images in said file listing area.

9. The tool of claim 1 further comprising an interactive view mode for interactive display of an image of an animal.

10. The tool of claim 9 further comprising a series of tabs for selecting between different anatomical presentations of said animal, wherein said selection changes said interactive display based on the anatomical system selected.

11. The tool of claim 10 wherein said displayed anatomical features are interactive linked to further images of said features.

12. The tool of claim 11 further comprising a hot spot menu that allows for selection and display of said further images interactively linked to anatomical features.

13. The tool of claim 12 wherein said further images are healthy and abnormal images of said anatomical features.

14. The tool of claim 13 wherein said healthy and abnormal images can be overlayed side by side in said main viewing area.

15. The tool of claim 13 wherein said further images are overlayed said animal image.

16. The tool of claim 1 wherein in the images include labels of key features of the images.

17. The tool of claim 1 further comprising a plurality of tools for editing and annotating said images.

18. The tool of claim 1 wherein said tab comprises a content tab which lists all of the images in the tool in said file viewing area.

19. The tool of claim 1 wherein said tab comprises a favorites tab which lists predetermined portion of said images of said tool in said file viewing area.

20. The tool of claim 1 further comprising videos an animations.

21. The tool of claim 20 wherein said videos and animations depict surgery procedures relating to said animal.

22. The tool of claim 21 wherein said tab is a surgery/animation tab which lists said animations and videos in said file viewing area.
